(19) United States
(12) Patent Application Publication
(10) Pub. No.: US 2024/0082101 A1
(43) Pub. Date: Mar. 14, 2024

(54) MASSAGE APPARATUS

(71) Applicant: SAMSUNG ELECTRONICS CO., LTD., Suwon-si (KR)

(72) Inventors: Taeseob LIM, Suwon-si (KR); Taeduk KIM, Suwon-si (KR); Hohyun RYU, Suwon-si (KR); Chanyoung PARK, Suwon-si (KR); Jiho JEONG, Suwon-si (KR); Hyunwoo KIM, Suwon-si (KR)

(21) Appl. No.: 18/217,007

(22) Filed: Jun. 30, 2023

Related U.S. Application Data
(63) Continuation of application No. PCT/KR2023/007528, filed on Jun. 1, 2023.

(30) Foreign Application Priority Data
Sep. 8, 2022 (KR) 10-2022-0114542

(51) Int. Cl. A61H 9/00

(52) U.S. Cl. CPC A61H 9/0078; A61H 2201/0149; A61H 2201/1246; A61H 2201/1623; A61H 2201/1635; A61H 2201/1654; A61H 2201/5007; A61H 2201/5038; A61H 2201/5048; A61H 2201/5056; A61H 2201/5058; A61H 2201/5082

(57) ABSTRACT

Provided is a massage apparatus comprising: a base frame comprising a seat portion, a back rest portion obliquely extending from the seat portion, and arm rest portions provided on both sides of the seat portion; a massage module coupled to a rear side of the back rest portion and configured to provide a massage to a user; air cells disposed in the arm rest portions and providing a massage to the user by expanding as air is introduced into the air cells; a compressor disposed below the seat portion and configured to discharge compressed air; and a duct providing a first flow path guiding air introduced into an inlet to the air cells, and a second flow path guiding air introduced into the inlet to the seat portion and the back rest portion. A valve, ambient sensors, and a processor direct the compressor to discharge air based on ambient conditions.

### CROSS-REFERENCE TO RELATED APPLICATION

This application is a continuation application, claiming priority under § 365(c), of International Application No. PCT/KR2023/007528, filed on Jun. 1, 2023, which is based on and claims the benefit of Korean patent application number 10-2022-0114542 filed on Sep. 8, 2022, in the Korean Intellectual Property Office, the disclosures of which are incorporated by reference herein in their entireties.

### TECHNICAL FIELD

The present disclosure relates to a massage apparatus.

### BACKGROUND

A massage apparatus is an apparatus for providing a massage to a user. The massage apparatus may be implemented in a structure such as a chair, booth, and couch on which a user may be seated.

In general, a massage apparatus may include a massage module for providing a massage to a user, a frame for supporting the user, and a frame cover covering the frame to provide a soft tactile sensation to the user. The frame cover may be formed of leather or fabric.

The user may receive a massage while in contact with the frame cover. In high temperature and humidity weather, the user's body in contact with the frame cover may sweat, which may cause the user to feel uncomfortable.

### SUMMARY

One aspect of the disclosure provides a massage apparatus capable of providing comfort to users even in high temperature and humidity weather.

One aspect of the disclosure provides a massage apparatus capable of providing an air blowing function in areas that come into contact with the user's body.

The technical objectives of the disclosure are not limited to the above, and other objectives may become apparent to those of ordinary skill in the art based on the following description.

A massage apparatus according to an aspect of the disclosure comprises: a base frame comprising a seat portion, a back rest portion obliquely extending from the seat portion, and arm rest portions provided on both sides of the seat portion; a massage module coupled to a rear side of the back rest portion and configured to provide a massage to a user; air cells disposed in the arm rest portions and providing a massage to the user by expanding as air is introduced into the air cells; a compressor disposed below the seat portion and configured to discharge compressed air; a duct comprising an inlet into which air discharged from the compressor is introduced, and forming a first flow path guiding air introduced into the inlet to the air cells, and a second flow path guiding air introduced into the inlet to the seat portion and the back rest portion; a valve coupled to the inlet, and configured to open and close the first flow path and the second flow path; a temperature sensor provided on the base frame and configured to measure an ambient temperature; and a processor obtaining temperature information based on a signal from the temperature sensor, and controlling the compressor to discharge air and controlling the valve to open the second flow path when the temperature information is equal to or higher than a first temperature.

### Advantageous Effects

According to one aspect of the disclosure, a massage apparatus providing comfort to users even in high temperature and humidity weather can be provided.

According to one aspect of the disclosure, a massage apparatus providing an air blowing function in areas that come into contact with the user's body can be provided.

The effects of the present disclosure are not limited to the above-described effects, and effects not described may be clearly understood by those of ordinary skill in the art from the present specification and the accompanying drawings.

### DESCRIPTION OF DRAWINGS

FIG. 1 is a perspective view of a massage apparatus according to an embodiment.

FIG. 2 schematically illustrates an internal configuration of the massage module of the massage apparatus shown in FIG. 1.

FIG. 3 illustrates a case, a compressor accommodated in the case, and valves and ducts of a massage apparatus according to an embodiment.

FIG. 4 illustrates FIG. 3 from a different angle.

FIG. 5 is a control block diagram of a massage apparatus according to an embodiment.

### MODES OF THE DISCLOSURE

Embodiments described in the specification and configurations shown in the accompanying drawings are merely examples of the present disclosure, and various modifications may replace the embodiments and the drawings of the present disclosure at the time of filing of the present application.

Further, identical symbols or numbers in the drawings of the present disclosure denote components or elements configured to perform substantially identical functions.

Further, terms used herein are only for the purpose of describing particular embodiments and are not intended to limit to the present disclosure. The singular form is intended to include the plural form as well, unless the context clearly indicates otherwise. It should be further understood that the terms “include,” “including,” “have,” and/or “having” specify the presence of stated features, integers, steps, operations, elements, components, and/or groups thereof, but do not preclude the presence or addition of one or more other features, integers, steps, operations, elements, components, and/or groups thereof.

Further, it should be understood that, although the terms “first,” “second,” etc., may be used herein to describe various elements, the elements are not limited by the terms, and the terms are only used to distinguish one element from another. For example, a first element could be termed a second element, and similarly, a second element could be termed a first element without departing from the scope of the present disclosure. The term “and/or” includes combinations of one or all of a plurality of associated listed items.

Meanwhile, the terms “front”, “rear”, “upper”, “lower”, “front”, “rear”, “top” and “bottom” used in the following description may be defined based on drawings, and the shape and position of each component may be not limited by the terms.

A massage apparatus according to an embodiment may include: a base frame comprising a seat portion, a back rest portion obliquely extending from the seat portion, and arm rest portions provided on both sides of the seat portion; a massage module coupled to a rear side of the back rest portion and configured to provide a massage to a user; air cells disposed in the arm rest portions and providing a massage to the user by expanding as air is introduced into the air cells; a compressor disposed below the seat portion and configured to discharge compressed air; a duct comprising an inlet into which air discharged from the compressor is introduced, and forming a first flow path guiding air introduced into the inlet to the air cells, and a second flow path guiding air introduced into the inlet to the seat portion and the back rest portion; a valve coupled to the inlet, and configured to open and close the first flow path and the second flow path; a temperature sensor provided on the base frame and configured to measure an ambient temperature; and a processor obtaining temperature information based on a signal from the temperature sensor, and controlling the compressor to discharge air and controlling the valve to open the second flow path when the temperature information is equal to or higher than a first temperature.

The massage apparatus may further comprise an input unit receiving commands from the user.

When the temperature information is lower than the first temperature, the processor may control the compressor to discharge air and may control the valve to open the second flow path, based on the user's command input to the input unit.

When the temperature information is equal to or higher than the first temperature, the processor may control the valve to close the second flow path, based on the user's command input to the input unit.

The massage apparatus may further comprise a humidity sensor provided on the base frame and configured to measure an ambient humidity.

The processor may obtain temperature information based on a signal from the humidity sensor, and may control the compressor to discharge air and controlling the valve to open the second flow path when the humidity information is equal to or higher than a first humidity.

The massage apparatus may further comprises an input unit receiving commands from the user.

When the humidity information is lower than the first humidity and the temperature information is lower than the first temperature, the processor may control the compressor to discharge air and may control the valve to open the second flow path, based on the user's command input to the input unit.

When the humidity information is equal to or higher than the first humidity and the temperature information is equal to or higher than the first temperature, the processor may control the valve to close the second flow path, based on the user's command input to the input unit.

The processor may control the compressor to discharge air and may control the valve to open the first flow path, based on the user's input on the operation of the air cells to the input unit.

The duct may have a plurality of holes formed through the duct to increase an area through which air is discharged from the rear side of the back rest portion.

The massage apparatus may further comprise a frame cover provided to cover the seat portion and the back rest portion.

The frame cover may comprise a plurality of first holes provided in an area corresponding to the seat portion, and a plurality of second holes provided in an area corresponding to the back rest portion.

The massage apparatus may further comprise a case provided below the seat portion of the base frame, and may be configured to accommodate the compressor and at least a portion of the duct.

Hereinafter, embodiments according to the present disclosure will be described in detail with reference to the accompanying drawings.

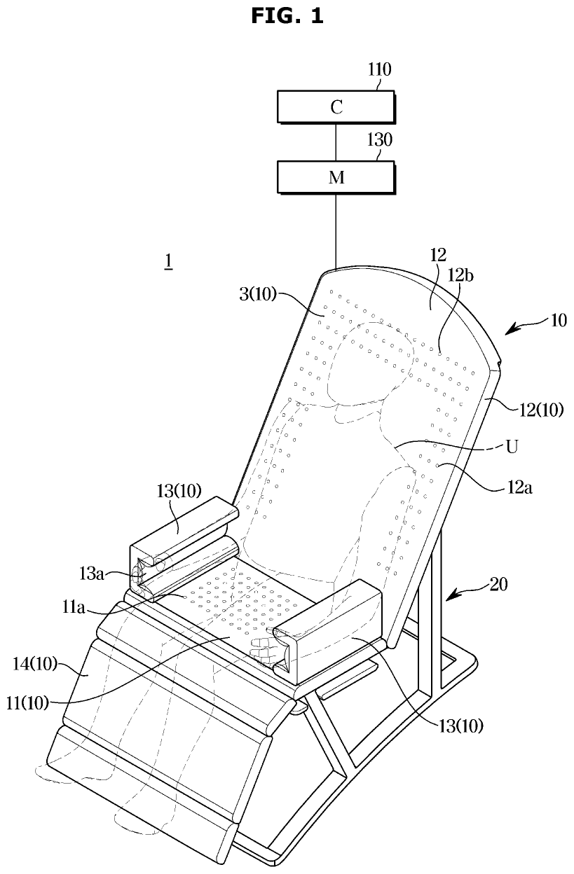

FIG. 1 is a perspective view of a massage apparatus 1 according to an embodiment.

A massage apparatus 1 is an apparatus that provides a user U with a massage. The massage apparatus 1 may be implemented in the form of a booth, couch, sofa, seat, bench, chair (as shown), etc. in which a user U may take a rest. The massage apparatus 1 may be covered by a frame cover 3. The frame cover 3 can be made of, for example, leather and/or cloth material to be in contact with a skin of the user U, although other materials, such as silks, fabrics, and other soft materials, are within the contemplated scope of this disclosure. Accordingly, since the material comes in contact with the user U's skin, the user U may experience a sense of psychological comfort.

The massage apparatus 1 may include a base frame 10 configured to support the user U. The base frame 10 may extend to support a head, an upper body, buttocks and lower body of the user U. The base frame 10 may form a resting surface on one side.

The resting surface of the base frame 10 may be provided to contact a body of the user U. For example, the resting surface of the base frame 10 may contact a rear of the user U's body to support the user U from the rear.

In the following description, the upper body and the lower body of the user U may be distinguished based on the buttocks of the user.

The base frame 10 may include a seat portion 11, a back rest portion 12, an arm rest portion 13, and a leg rest portion 14. The seat portion 11 may support the buttocks and a portion of the legs of the body of the user U. The back rest portion 12 may support a portion of the head, or the entire head, and an upper torso of the user's body. The arm rest portion 13 may be configured to wrap around the arms of the user. The leg rest portion 14 may support the remaining portion of the user's legs.

The back rest portion 12 may be connected to the seat portion 11. The back rest portion 12 may extend inclined from one end of the seat portion 11. The leg rest portion 14 may extend inclined from the other end of the seat portion 11.

Although not shown in the drawings, the leg rest portion 14 may be shaped to wrap around the calf of the user U in a similar manner as shown for the arm rest portion 13. In this case, the leg rest portion 14 may include an air cell therein, as may the arm rest portion 13.

In some embodiments, the massage apparatus 1 includes a support frame 20. The support frame 20 may be configured to support the base frame 10. The support frame 20 may support the base frame 10 such that the massage apparatus 1 is self-supporting. The support frame 20 may be coupled to a lower side of the base frame 10.

The base frame 10 and the support frame 20 are merely one example of the disclosure, the base frame 10 and the support frame 20 may be provided in various shapes that support the body of the user U.

The massage apparatus 1 may include a frame cover 3 configured to cover the base frame 10. The frame cover 3 may be provided with a soft material to provide comfort for the user U when user U is seated. The frame cover 3 may include a plurality of first holes 11a provided in a region corresponding to the seat portion 11, a plurality of second holes 12a provided in a region corresponding to the back rest portion 12, and a plurality of third holes 12b provided in a region corresponding to a region of contact with a neck and/or head of the user U. The plurality of first holes 11a may be configured to provide airflow to a portion of the buttocks and legs of the user U. The plurality of second holes 12a may be configured to provide airflow to the shoulders and arms on either side of the user U, and the plurality of third holes 12b may be configured to provide airflow to the neck and occipital portions of the user.

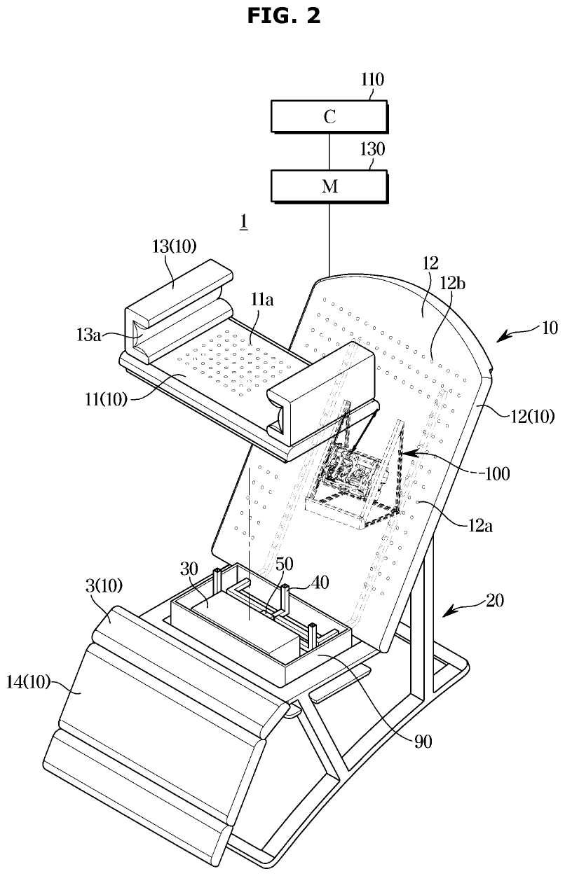

FIG. 2 schematically illustrates an internal configuration of the massage module of the massage apparatus shown in FIG. 1.

Referring to FIG. 2, the massage apparatus 1 may include a massage module 100 capable of providing a massage to the user U. The massage module 100 may be positioned at the rear of the back rest portion 12 of the base frame 10 to provide a massage from the head to the waist of the user U. The location of the massage module is illustrative but is not limited thereto. Massage modules capable of providing a massage to some or all of the lower half of the user U may be provided in the base frame 10, separate from the illustrated massage module 100 (additional massage modules not shown).

The massage apparatus 1 may include a case 90 provided below the seat portion 11. The case 90 may be provided in a form of a box with an open top surface. Inside the case 90, a compressor 30, a valve 50, and at least a portion of a duct 40 may be provided. The duct 40 may include a portion extending through a through hole 44 provided in the case 90 to a rear side of the back rest portion 12.

Arm rest portions 13 may be provided on either side of the seat portion 11. The arm rest portions 13 may form a receiving space on the inner side to accommodate the arms of the user U. An air cell 13a may be provided in the receiving space. The air cell 13a may provide a massage to the arm of the user U by contracting and expanding.

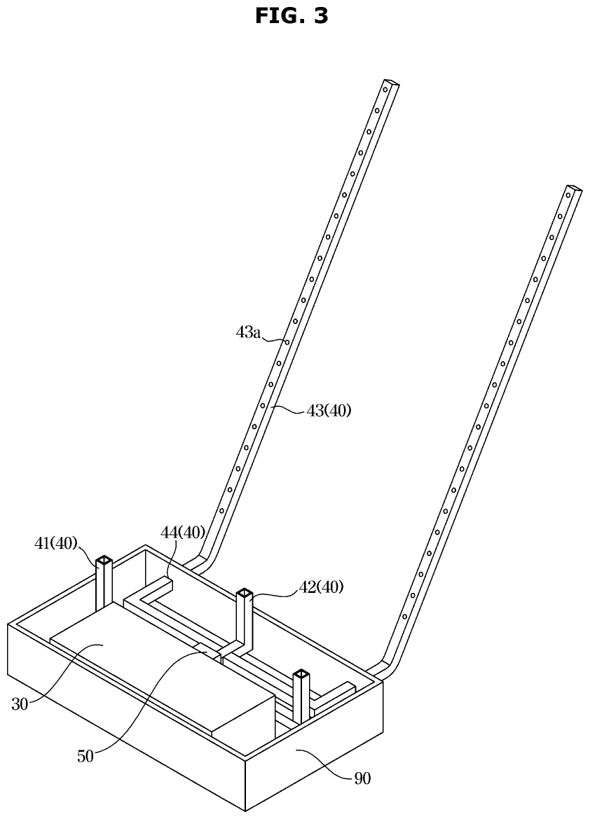

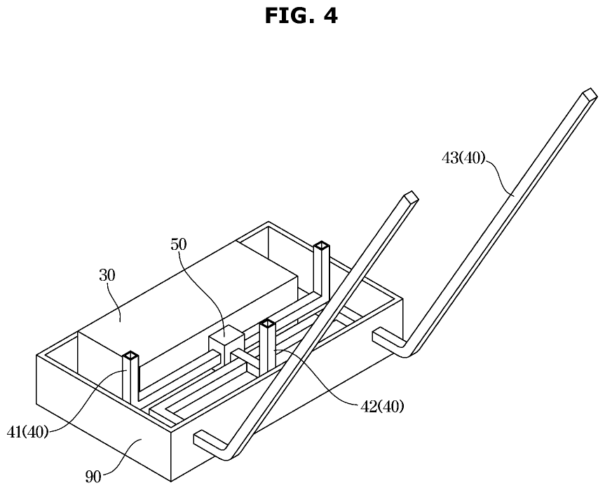

FIG. 3 separately illustrates a case, a compressor accommodated in the case, and valves and ducts in a massage apparatus according to an embodiment. FIG. 4 illustrates FIG. 3 from a different angle.

Referring to FIG. 3 and FIG. 4, the massage apparatus 1 may include a compressor 30 configured to discharge compressed air, a valve 50 configured to control a path of air discharged from the compressor 30, and a duct 40 guiding air discharged from the compressor 30 to the air cell 13a, the seat portion 11, and the back rest portion 12.

The compressor 30 and the valve 50 may be disposed inside the case 90. A portion of the duct 40 may be arranged on the interior of the case 90. The duct 40 may include an inlet through which air discharged from the compressor 30 is introduced, and a valve 50 may be coupled to the inlet. The valve 50 may be arranged between the inlet of the duct 40 and the air outlet of the compressor 30 to control the path of travel of the air exiting the compressor 30.

The duct 40 may include a first duct 41 forming a first flow path guiding air introduced into the inlet to the air cell 13a, a second duct 42 forming a second flow path guiding air from the inlet to the seat portion 11, and a third duct 43 forming a third flow path guiding air from the inlet to the back rest portion 12. While not separately shown, the duct 40 may include a fourth duct forming a fourth path guiding air from the inlet to the leg rest portion 14. The second and third ducts 42, 43 may be configured to be simultaneously open or simultaneously closed. The second and third flow paths (also referred to as channels) may be collectively referred to as blowing path(s) and the first flow path can be referred to as a discharge path.

The third duct 43 may extend along a direction in which the back rest portion 12 extends. The third duct 43 may include a plurality of holes 43a. Through the plurality of holes 43a, air passing through the third duct 43 may be exhausted at various locations along the back rest portion 12.

The valve 50 may be configured to open and close the first flow path of the duct 40 and the blowing path. The valve 50 may inject air discharged from the compressor 30 into the air cell 13a by opening the first flow path. Alternatively, in embodiments where the massage apparatus 1 does not include the arm rest portion 13 and/or the air cell 13a (not separately shown), the first duct 41 forming the first flow path can be configured to discharge air directly from the massage apparatus 1. The valve 50 may allow air discharged from the compressor 30 to be discharged from the seat portion 11 and the back rest portion 12 by opening the blowing path.

The valve 50 may simultaneously open or close the first flow path and the blowing path, or open or close either one of the first flow path and the blowing path.

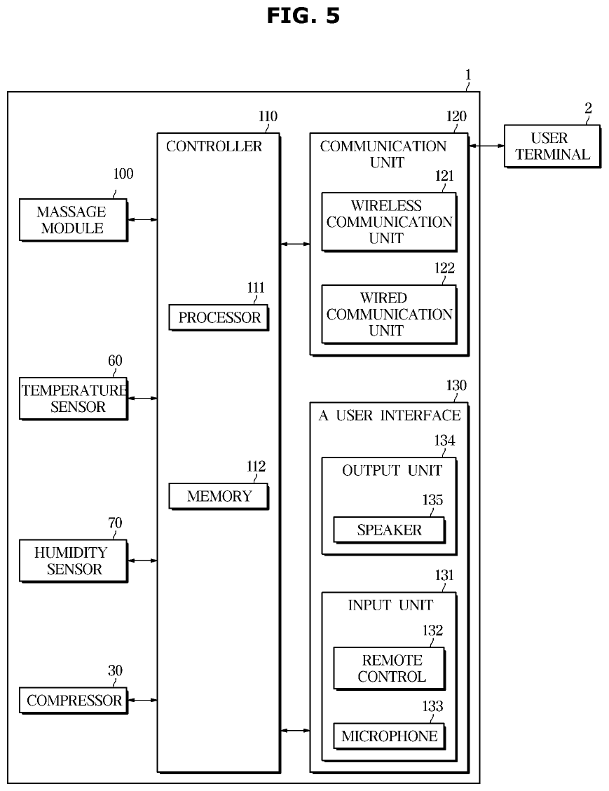

FIG. 5 is a control block diagram of a massage apparatus according to an embodiment.

Referring to FIG. 5, a massage apparatus 1 according to an embodiment may include a massage module 100, a temperature sensor 60, a humidity sensor 70, a controller 110, a communication unit 120, and a user interface 130.

Specifically, the massage apparatus 1 includes a massage module 100 for providing a massage to the body of the user U, a communication unit 120 including a wireless communication unit 121 and a wired communication unit 122 to communicate with the user terminal 2, a user interface 130 including an input unit 131 for inputting a command of the user U and an output unit 134 for responding to the command, a temperature sensor 60 for sensing the ambient temperature, It may include a humidity sensor 70 for sensing the humidity of and a controller 110 electrically connected to the aforementioned components to control the massage apparatus 1.

Specifically, the massage apparatus 1 includes a massage module 100 for providing a massage to the body of the user U, a communication unit 120 including a wireless communication unit 121 and a wired communication unit 122 for communicating with the user terminal 2, a user interface 130 including an input unit 131 for inputting commands from the user U and an output unit 134 for responding to the commands, a temperature sensor 60 for sensing an ambient temperature, a humidity sensor 70 for sensing an ambient humidity, and a controller 110 electrically connected to the aforementioned components to control the massage apparatus 1.

The massage module 100 is mechanically connected to the base frame 10 as described above in FIGS. 1 and 2, and can be moved up and down or side to side relative to the back rest portion 12, and can provide a massage to the body of the user U.

The arm rest portion 13 may include an air cell 13a, and may provide a massage to the body of the user U based on contracting and expanding of the air cell 13a.

The communication unit 120 may transmit data to an external device or receive data from an external device based on the control of the controller 110. For example, the communication unit 120 may communicate with the server and/or the user terminal 2 and/or additional external devices, such as a home appliance, to transmit and receive various data.

To this end, the communication unit 120 may support the establishment of direct (e.g., wired) or wireless communication channels between external electronic devices (e.g., servers, user terminals 2 and/or home appliances), establishing a direct (e.g., wired) communication channel or a wireless communication channel, and performing communication via the established communication channel. According to an embodiment, the communication unit 120 may include a wireless communication unit 121 (e.g., a cellular communication module, a near field communication module, or a global navigation satellite system (GNSS) communication module) or a wired communication unit 122 (e.g., a local area network (LAN) communication module, or a power line communication module). Any of these communication modules may communicate with external electronic devices via a first network (e.g., a short-range communication network such as Bluetooth, wireless fidelity (WiFi) direct, or infrared data association (IrDA)) or a second network (e.g., a long-range communication network such as a legacy cellular network, 5G network, next generation communication network, the Internet, or a computer network (e.g., LAN or WAN)). These different types of communication modules can be integrated into a single component (e.g., a single chip) or implemented as multiple separate components (e.g., multiple chips).

In various embodiments, the communication unit 120 may establish communication with the user terminal 2 via a server (not separately shown).

In various embodiments, the communication unit 120 may include a Wi-Fi module and may perform communication with an external server and/or the user based on establishing communication with an access point (AP) within the home.

The user interface 130 may comprise an input unit 131 and an output unit 134, and may provide an interface for the user U and the massage apparatus 1 to interact.

The input unit 131 may include a remote control 132 for remotely controlling the massage apparatus 1 and a microphone 133 for receiving voice input from the user U.

The remote control 132 may be wired or wirelessly connected to the massage apparatus 1 and may include a power button, an action button, a channel selection dial and sound selection dial, a voice-activated start button, and a detailed settings button. Additionally, the remote control 132 may be provided as a tact switch, a push switch, a slide switch, a toggle switch, a micro switch or a touch switch.

The microphone 133 may begin receiving speech by a voice recognition start button provided on the remote control 132. The microphone 133 may receive voice commands from the user U to obtain commands to be analyzed by the voice recognition system.

Accordingly, the input unit 131 may receive user (U) inputs, such as changing the course of the massage apparatus 1, adjusting the sound, and starting voice recognition, and transfer them to the controller 110.

The output unit 134 may include a speaker 135 provided within or outside the massage apparatus 1.

Specifically, the output unit 134 may output a notification to the speaker 135 in response to an input from the user U regarding the operation of the massage apparatus 1, and may further be equipped with an external lamp (not shown) to flash the external lamp in response to the input from the user U. The output unit 134 may also output a sound of content received from the user terminal 2. In addition, the output unit 134 may output the sound of the content received from the user terminal 2.

Temperature sensor 60 is configured to measure ambient temperature.

The humidity sensor 70 is configured to measure ambient humidity.

The sensors 60, 70 included in the massage apparatus 1 according to an embodiment may include various sensors in addition to the temperature sensor 60 and humidity sensor 70 described above.

The controller 110 may include a processor 111 for generating control signals for operation of the massage apparatus 1, and a memory 112 for storing programs, applications, instructions, and/or data for operation of the massage apparatus 1. The processor 111 and the memory 112 may be implemented as separate semiconductor devices, or may be implemented as a single semiconductor device. Further, the controller 110 may include a plurality of processors 111 or a plurality of memories 112. The controller 110 may be disposed in various locations within the massage apparatus 1.

The processor 111 may include computation circuitry, memory circuitry, and control circuitry. The processor 111 may include a single chip or a plurality of chips. Further, the processor 111 may include a single core or a plurality of cores.

The memory 112 may store data including a program for controlling the massage apparatus 1 according to a user (U) command, and settings of the massage apparatus 1 according to an input value. In addition, the memory 112 may store sound data of content received from the user terminal 2.

The memory 112 may include volatile memory, such as static random access memory (S-RAM) and dynamic random access memory (D-RAM), and non-volatile memory, such as read only memory (ROM) and erasable programmable read only memory (EPROM). The memory 112 may include a single memory element or may include a plurality of memory elements.

The processor 111 may process the data and/or signals using programs provided from the memory 112, and may send control signals to each components of the massage apparatus 1 based on the results of the processing. For example, the processor 111 may process user input received via the remote control 132, and the processor 111 may control the communication unit 120 to receive user input or content from the user terminal 2.

In another example, the processor 111 may control the operation of the compressor 30 and the valve 50 based on temperature information from the temperature sensor 60.

In another example, the processor 111 may control the operation of the compressor 30 and the valve 50 based on user input to the input unit 131.

Hereinafter, the operation of the massage apparatus 1 according to an embodiment will be described.

The processor 111 may obtain temperature information measured by the temperature sensor 60. The processor 111 may control the compressor 30 to operate the compressor 30 if the temperature information is above a first temperature. The processor 111 may control the valve 50 to open the blowing path if the temperature information is above the first temperature.

The processor 111 may obtain an input from the user input to the input unit 131. If the user has entered an input into the input unit 131 that operates the blowing function, the processor 111 may control the compressor 30 to operate the compressor 30 based on the user's input, and the processor 111 may control the valve 50 to open the blowing path. If the user provides input to the input unit 131 that operates the blowing function, the compressor 30 and the valve 50 may be controlled as described above, even if the temperature information measured by the temperature sensor 60 is less than the first temperature.

The processor 111 may control the valve 50 to close the blowing path, based on the input from the user, if the temperature information measured by the temperature sensor 60 is above the first temperature and the user has entered an input into the input unit 131 that turns off the blowing function.

The processor 111 may obtain humidity information measured by the humidity sensor 70. The processor 111 may control the compressor 30 to operate the compressor 30 if the humidity information is above a first humidity. The processor 111 may control the valve 50 to open the blowing path if the humidity information is above the first humidity.

The processor 111 may control the compressor 30 to operate if the humidity information is above the first humidity and/or the temperature information is above the first temperature. The processor 111 may control the valve 50 to open the blowing path when the humidity information is above the first humidity. In other words, the processor 111 may control the valve 50 to operate the compressor 30 and open the blowing path when either the humidity or the temperature is above a predetermined threshold.

The processor 111 may control the valve 50 to close the blowing path if the humidity information is below a first humidity and the temperature information is below a first temperature. In other words, the processor 111 may control the valve 50 to close the blowing path if each of the humidity and temperature is below a predetermined threshold.

As mentioned above, the massage apparatus 1 may or may not provide a blowing function to the seat portion 11, the back rest portion 12, and/or the leg rest portion 14 based on the ambient temperature and the ambient humidity measured via the sensors 60, 70 and input from the user U. This allows the user U to receive a massage in a comfortable condition, as airflow is provided in the area in contact with the body, even when the weather is humid or hot.

Although the disclosure has been shown and described in relation to specific embodiments, it would be appreciated by those skilled in the art that changes and modifications may be made in these embodiments without departing from the principles and scope of the invention, the scope of which is defined in the claims and their equivalents.

1. A massage apparatus comprising:
a base frame comprising a seat portion, a back rest portion obliquely extending from the seat portion, and arm rest portions provided on both sides of the seat portion;
a massage module coupled to a rear side of the back rest portion and configured to provide a massage to a user;
air cells disposed in the arm rest portions and providing a massage to the user by expanding as air is introduced into the air cells;
a compressor disposed below the seat portion and configured to discharge compressed air;
a duct comprising an inlet into which air discharged from the compressor is introduced, and forming a first flow path guiding air introduced into the inlet to the air cells, and a second flow path guiding air introduced into the inlet to the seat portion and the back rest portion;
a valve coupled to the inlet, and configured to open and close the first flow path and the second flow path;
a temperature sensor provided on the base frame and configured to measure an ambient temperature; and
a processor obtaining temperature information based on a signal from the temperature sensor, and controlling the compressor to discharge air and controlling the valve to open the second flow path when the temperature information is equal to or higher than a first temperature.

2. The massage apparatus of claim 1, further comprising an input unit receiving commands from the user; and
wherein, when the temperature information is lower than the first temperature, the processor controls the compressor to discharge air and controls the valve to open the second flow path, based on the user's command input to the input unit.

3. The massage apparatus of claim 2, wherein when the temperature information is equal to or higher than the first temperature, the processor controls the valve to close the second flow path, based on the user's command input to the input unit.

4. The massage apparatus of claim 1, further comprising a humidity sensor provided on the base frame and configured to measure an ambient humidity; and
wherein the processor obtains humidity information based on a signal from the humidity sensor, and controls the compressor to discharge air and controlling the valve to open the second flow path when the humidity information is equal to or higher than a first humidity.

5. The massage apparatus of claim 4, further comprising an input unit receiving commands from the user; and
wherein when the humidity information is lower than the first humidity and the temperature information is lower than the first temperature, the processor controls the compressor to discharge air and controls the valve to open the second flow path, based on the user's command input to the input unit.

6. The massage apparatus of claim 5, wherein when the humidity information is equal to or higher than the first humidity and the temperature information is equal to or higher than the first temperature, the processor controls the valve to close the second flow path, based on the user's command input to the input unit.

7. The massage apparatus of claim 5, wherein the processor controls the compressor to discharge air and controls the valve to open the first flow path, based on the user's input on the operation of the air cells to the input unit.

8. The massage apparatus of claim 1, wherein the duct has a plurality of holes to increase an area through which air is discharged from the rear side of the back rest portion.

9. The massage apparatus of claim 1, further comprising a frame cover provided to cover the seat portion and the back rest portion; and
wherein the frame cover comprises:
a plurality of first holes provided in an area corresponding to the seat portion, and
a plurality of second holes provided in an area corresponding to the back rest portion.

10. The massage apparatus of claim 1, further comprising a case provided below the seat portion of the base frame, and configured to accommodate the compressor and at least a portion of the duct.

11. A massage apparatus comprising:
a base frame comprising a seat portion and a back rest portion extending from the seat portion;
a massage module coupled to the back rest portion and configured to provide a massage to a user;
a compressor disposed below the seat portion and configured to discharge compressed air;
a duct comprising an inlet into which air discharged from the compressor is introduced, and forming a first flow path discharging air introduced into the inlet from the massage apparatus, and a second flow path guiding air introduced into the inlet to the seat portion and the back rest portion;
a valve coupled to the inlet, and configured to open and close the first flow path and the second flow path;
a sensor configured to measure an ambient condition, wherein the sensor comprises one or more of a temperature sensor and a humidity sensor, and wherein the ambient condition comprises one or more of an ambient temperature and an ambident humidity; and
a processor obtaining ambient condition information based on a signal from the sensor, and controlling the compressor to discharge air and controlling the valve to open the second flow path when the ambient condition information is equal to or higher than a first threshold.
